(19) United States
(12) Patent Application Publication
(10) Pub. No.: US 2009/0122552 A1
(43) Pub. Date: May 14, 2009

(54) Low power consumption high illumination LED lamp

(75) Inventor: Jeng-Fuh Liu, Taipei City (TW)

Correspondence Address: BACON & THOMAS, PLLC, 625 SLATERS LANE, FOURTH FLOOR, ALEXANDRIA, VA, 22314-1176, US

(73) Assignee: CHUNTLON ENTERPRISE CO., LTD., Taipei City (TW)

(21) Appl. No.: 11/979,864

(22) Filed: Nov. 9, 2007

(51) Int. Cl. F21V 29/00

(52) U.S. Cl. 362/294

(57) ABSTRACT

This invention is to provide a low power consumption high illumination LED lamp comprising a base; a metallic member on a bottom of the base and adapted to insert into a socket; an AC to DC converter disposed inside the base and being electrically connected to the metallic member; a heat sink formed of metal and disposed on a top of the base; at least one matrix shaped LED light array secured to a position outside the base and adjacent to the heat sink and electrically connected to the AC to DC converter, and a bulb having a peripheral edge secured to the top of the base and covering matrix shaped LED light array. By utilizing this lighting device, advantages including low power consumption, high illumination, increased illuminating area, energy saving, and being complied with the concept of environmental protection are obtained.

### FIELD OF THE INVENTION

The invention relates to LED (light-emitting diode) lighting devices and more particularly to an LED lamp with characteristics including low power consumption, high illumination, etc.

### BACKGROUND OF THE INVENTION

Technologies and science have made progress significantly in recent several decades. Accordingly, people have a strong desire for the improvement of living quality. Also, a wide variety of novel products are available. These products include not only advanced electronic products but also consumer-oriented products. Further, these products are more convenient in use, practical, and visually attractive. Furthermore, whether a product is environment friendly and/or energy saving is also an important consideration factor when a person desires to buy such type of product due to the increasing environmental concern among people worldwide. Thus, as a trend more and more manufacturers invest a great amount of money on the development of products satisfying the above needs.

Fluorescent lamps are widely used as illumination device throughout the world. However, fluorescent lamps may damage the environment in the disposal stage after its useful life ends. Thus, an energy saving lamp for keeping up with the trend of environmental protection and as an improvement of the conventional fluorescent lamp is developed as shown in FIG. 1. The energy saving lamp comprises a housing 10, a metallic element 11, and a light tube 12. The metallic element 11 is provided on a bottom of the housing 10 and is adapted to insert into a socket having, for example, two prongs for inserting into an outlet for mounting the energy saving lamp on a fixed position (e.g., ceiling or wall). Power thus can be supplied to the energy saving lamp through the outlet and the metallic element 11. The light tube 12 is provided on a top of the housing 10. Two ends of the light tube 12 are provided inside the housing 10 and the remaining portion thereof is shaped as a helix extending out of the top of the housing 10. By configuring as above, light rays emanated from the light tube 12 are adapted to provide illumination.

The conventional energy saving lamp can do less damage to the environment in the disposal stage as compared with the typical fluorescent lamp. However, in fact it still has the following drawbacks:

1) Inner illumination surface of the light tube 12 at one side is blocked by a portion of the light tube 12 at the opposite side. Thus, the effective luminous flux of the light tube 12 of the energy saving lamp is decreased about 30%.

2) Heat dissipation performance of the energy saving lamp is poor due to the helical shape of the light tube 12.

3) Light output can be decreased significantly when temperature rises. And in turn, the total illumination performance is lowered.

4) Not only a large package is required but also padding is required when packing the specially shaped light tube 12. Otherwise, the energy saving lamp may be damaged due to collision in delivery. This inevitably will increase the cost and difficulties of package.

Thus, it is desirable among the manufacturers of the art to provide a novel lighting device of low power consumption and high illumination in order to save energy and not damage the environment.

### SUMMARY OF THE INVENTION

After considerable research and experimentation, a low power consumption high illumination LED lamp according to the invention has been devised so as to overcome the above drawback of the prior art.

It is an object of the invention to provide a low power consumption high illumination LED lamp comprising a base; a metallic member on a bottom of the base and adapted to insert into a socket; an AC to DC converter disposed inside the base and being electrically connected to the metallic member; a heat sink formed of metal and disposed on a top of the base; at least one matrix shaped LED light array secured to a position outside the base and adjacent to the heat sink and electrically connected to the AC to DC converter, and a bulb having a peripheral edge secured to the top of the base and covering matrix shaped LED light array. By utilizing this lighting device, advantages including low power consumption, high illumination, increased illuminating area, energy saving, and being complied with the concept of environmental protection are obtained.

The above and other objects, features and advantages of the invention will become apparent from the following detailed description taken with the accompanying drawings.

### BRIEF DESCRIPTION OF THE DRAWINGS

FIG. 1 is a perspective view of a conventional energy saving lamp;

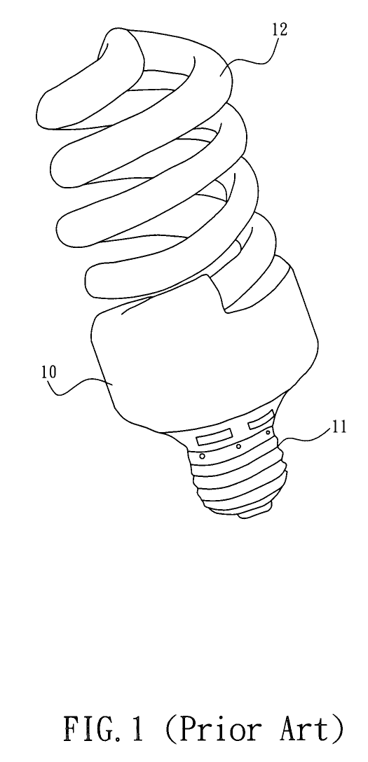

FIG. 2 is a perspective view of a first preferred embodiment of low power consumption high illumination LED lamp according to the invention;

FIG. 3 is an exploded view of the lamp shown in FIG. 2;

FIG. 4 is a perspective view of a second preferred embodiment of low power consumption high illumination LED lamp according to the invention; and

FIG. 5 is a sectional view of the matrix shaped LED light array according to either preferred embodiment of the invention.

### DETAILED DESCRIPTION OF THE PREFERRED EMBODIMENTS

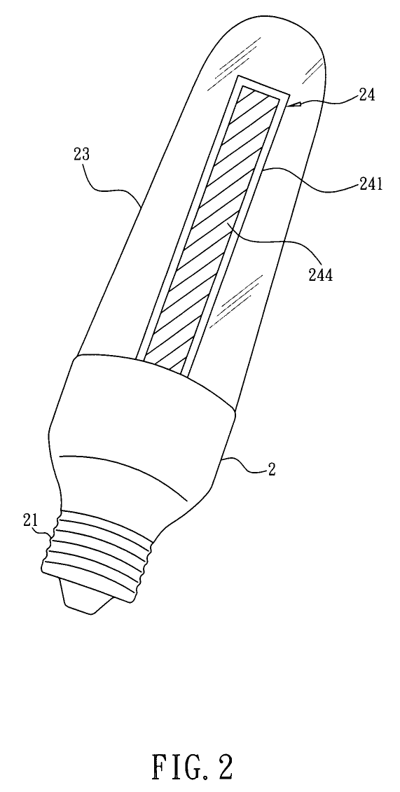

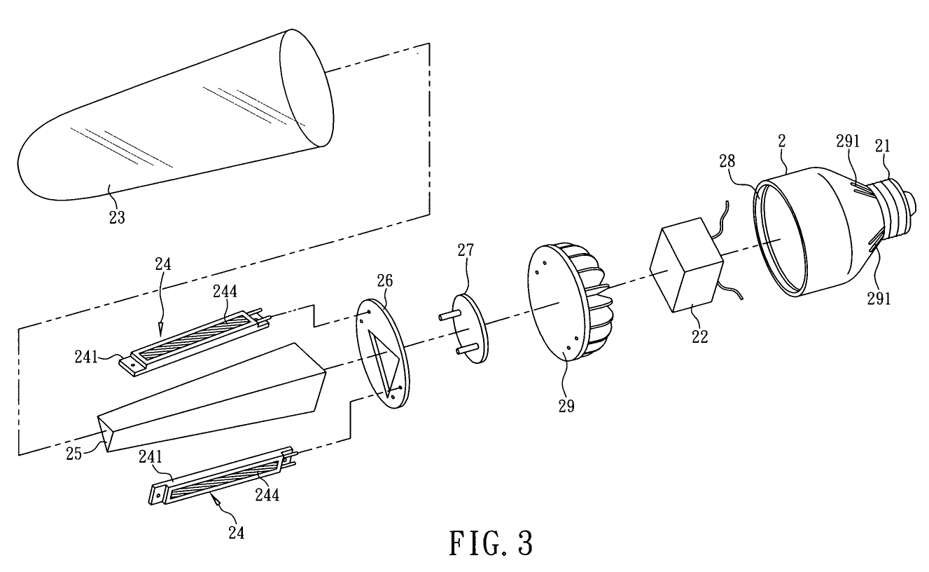

Referring to FIGS. 2 and 3, a low power consumption high illumination LED lamp in accordance with a first preferred embodiment of the invention is shown. The lamp comprises a base 2, a metallic element 21, an AC to DC converter 22, a bulb 23, a circular plate shaped metal heat sink 29 having a plurality of spaced fins formed on one surface, and a plurality of matrix shaped LED light arrays 24. Each component is discussed in detail below.

The metallic element 21 is provided on a bottom of the base 2 and is adapted to insert into a socket installed on a fixed position (e.g., ceiling or wall). Thus, the lamp can be mounted on the ceiling or wall, and AC power can be supplied to the lamp through the socket and the metallic element 21. The AC to DC converter 22 (e.g., Universal 90-260V AC to 13V DC) is provided within the base 2. The AC to DC converter 22 is electrically connected to the metallic element 21 for converting AC power supplied from the socket into DC having a predetermined voltage and power which are complied with the requirements of the matrix shaped LED light array 24.

The bulb 23 has a peripheral edge secured to an annular top edge of the base 2. The bulb 23 is made of a transparent material or translucent plastic or acrylic. The heat sink 29 is also provided inside the base 2 at a position that the surface of the heat sink 29 having the spaced fins is adjacent to the AC to DC converter 22. The matrix shaped LED light arrays 24 are of rectangular and are fixed to a position adjacent to the other surface of the heat sink 29, which is opposite to the surface of the heat sink 29 having the spaced fins, and covered by the bulb 23. The heat sink 29 is adapted to dissipate heat generated by the matrix shaped LED light arrays 24. The matrix shaped LED light arrays 24 are thus well dissipated as compared with non-matrix shaped LED light arrays which may have generated heat concentrated on certain area, resulting in a lowering of light output or even no light output. A plurality of surface slits 291 are provided on a bottom of the base 2 at positions adjacent to the metallic element 21 and corresponding to the fins of the heat sink 29. The slits 291 are adapted to dissipate the heat generated by the AC to DC converter 22 and the matrix shaped LED light arrays 24. The light rays emanated from the matrix shaped LED light arrays 24 are adapted to pass the bulb 23 for illumination.

The matrix shaped LED light array 24 has advantages of prolonged useful life, low power consumption, high illumination, being durable, being vibration-resistant, being sturdy, being mass-produced, being compact, and quick activation time. The LED lamp thus is highly illuminated, environment friendly, and without drawbacks associated with the well known lighting devices. The heat sink 29 not only can dissipate heat generated by the AC to DC converter 22 but also can lower temperature of the enabled matrix shaped LED light arrays 24. Large current of constant voltage can be supplied to the LED lamp of the invention. It is envisaged by the invention that the matrix shaped LED light arrays 24 as compared with non-matrix shaped LED light arrays can increase intensity of illumination by about 30%. As a result, the illumination effect is greatly increased.

In the first preferred embodiment of the invention, the bulb shaped lamp can be redesigned as one having a lighting tube similar to that of a fluorescent lamp. Referring to FIGS. 2 and 3 again, the LED lamp further comprises a bracket 25 of truncated pyramid shaped. The matrix shaped LED light arrays 24 (only two are shown) are mounted on three side surfaces of the bracket 25. Hence, illuminating area and range of the matrix shaped LED light arrays 24 are greatly increased. One end surface of the bracket 25 is fixed to a position adjacent to the other surface of the heat sink 29, which is opposite to the surface of the heat sink 29 having the spaced fins, and the other end surface thereof is disposed adjacent to a top point inside of the bulb 23. In addition to fixing the matrix shaped LED light arrays 24 to the other surface of the heat sink 29, the bracket 25 can also dissipate heat generated by the matrix shaped LED light arrays 24 to the heat sink 29.

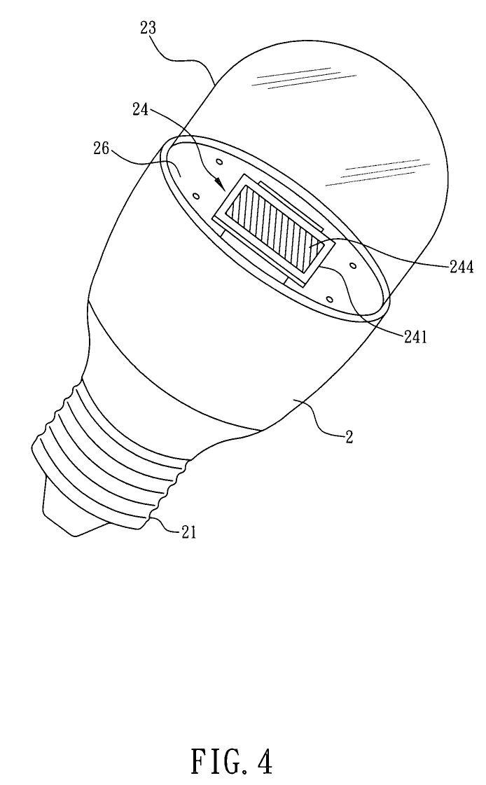

Referring to FIG. 4, in a second preferred embodiment of the invention, the matrix shaped LED light array 24 is shaped as a square and is secured to a top of the base 2. The bulb 23 is shaped as a dome. This can greatly decrease the size of the LED lamp. For example, the LED lamp is mounted directly below a ceiling with its emitted light directed toward all directions.

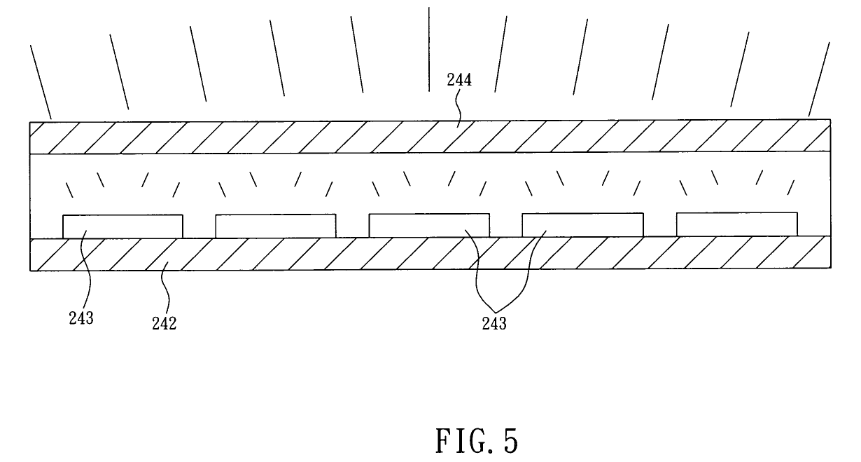

Referring to FIG. 5 in conjunction with FIGS. 3 and 4, in the first and second preferred embodiments of the invention the matrix shaped LED light array 24 is comprised of a frame 241, a substrate 242, and a transparent cover 244. The substrate 242 is provided on a bottom of the frame 241. A plurality of LEDs 243 are provided on the substrate 242. The LED 243 is adapted to emit blue or violet light. The transparent cover 244 is provided on a top of the frame 241 and is formed of phosphorus. The phosphorus of the transparent board 244 can be excited when the LEDs 243 emit blue or violet light. As a result, a very bright light is rendered by the matrix shaped LED light arrays 24. Further, the matrix shaped LED light arrays 24 have an enhanced heat dissipation capability as compared with non-matrix shaped LED light arrays. Thus, a large current of constant voltage can be supplied to the LED lamp of the invention. It is envisaged by the invention that the LED lamp can increase intensity of illumination by about 30% to 50%. As a result, a lamp of low power consumption, high illumination, and being environment friendly is effected by the invention.

Referring to FIGS. 3 and 4 again in the first and second preferred embodiments of the invention, a disc shaped mounting member 26 having a triangular center opening is fixed to a position adjacent to the other surface of the heat sink 29 not having the spaced fins, so that the bracket 25 is adapted to partially pass the mounting member 26 through the opening and is then fastened to the top of the base 2 adjacent to the other surface of the heat sink 29. Further, the matrix shaped LED light arrays 24 have projecting pins (not numbered) inserted into holes (not numbered) of the mounting member 26 and then electrically connected to the AC to DC converter 22. An abutment disc 27 is provided between the mounting member 26 and the heat sink 29, and has projecting pins (not numbered) to be electrically interconnected the matrix shaped LED light arrays 24 and the AC to DC converter 22 for supplying DC current to the matrix shaped LED light arrays 24.

Referring to FIGS. 3 and 4 again in the first and second preferred embodiments of the invention, one end of the AC to DC converter 22 coupling to the metallic element 21 is an AC input terminal and the other end of the AC to DC converter 22 coupling to the abutment disc 27 is a DC output terminal. The rated DC output voltage is in a range of 12.5V to 13.5V and has a luminance of 80 lumen per waft. Output power is 3 waft when only one matrix shaped LED light array 24 is used and output power is 9 waft when three matrix shaped LED light arrays 24 are used. The heat sink 29 and the slits 291 can enhance the heat dissipation of the LED lamp. Large current of constant voltage can be supplied to the LED lamp for increasing intensity of illumination by about 30%. Further, a rim 28 is provided on a top edge of the base 2. The rim 28 has annular groove(s) matingly engaged with the bulb 23 for fastening the bulb 23 onto the base 2.

In brief, the low power consumption high illumination LED lamp of the invention has advantages of being vibration-resistant, being compact, quick activation time, being complied with the concept of environmental protection, without the drawbacks of low luminous flux, poor heat dissipation, and low performance of the well known energy saving lamp, and being protected by the bulb 23 for preventing the LED lamp from being damaged in package and delivery due to collision.

While the invention herein disclosed has been described by means of specific embodiments, numerous modifications and variations could be made thereto by those skilled in the art without departing from the scope and spirit of the invention set forth in the claims.

What is claimed is:

1. A low power consumption high illumination LED lamp comprising:
a base;
a metallic member on a bottom of the base and being adapted to insert into a socket;
an AC to DC converter being disposed inside the base and electrically connected to the metallic member;
a heat sink formed of metal, the heat sink being disposed inside the base at a position that one surface of the heat sink is adjacent to the AC to DC converter;
at least one matrix shaped LED light array secured to a position outside the base and adjacent to the other surface of the heat sink and being electrically connected to the AC to DC converter; and
a bulb having a peripheral edge secured to a top of the base and covering the matrix shaped LED light array.

2. The low power consumption high illumination lighting device of claim 1, wherein the base comprises at least one surface slit provided on a bottom of the base at position adjacent to the metallic element and corresponding to the one surface of the heat sink 29.

3. The low power consumption high illumination LED lamp of claim 2, wherein each matrix shaped LED light array comprises:
a frame;
a substrate on a bottom of the frame and a plurality of LEDs provided on the substrate; and
a transparent cover on a top of the frame and being formed of phosphorus.

4. The low power consumption high illumination LED lamp of claim 3, further comprising a bracket having one end secured to a position outside the base and adjacent to the other surface of the heat sink and the other end disposed adjacent to a top point inside of the bulb.

5. The low power consumption high illumination LED lamp of claim 4, wherein each matrix shaped LED light array is rectangular and is secured onto a surface of the bracket.

6. The low power consumption high illumination LED lamp of claim 3, wherein each matrix shaped LED light array is square and is secured to a position outside the base and adjacent to the other surface of the heat sink.

7. The low power consumption high illumination LED lamp of claim 5, further comprising:
a mounting member secured to a position outside the base and adjacent to the other surface of the heat sink; and
an abutment member disposed between the mounting member and the heat sink and being electrically interconnected the at least one matrix shaped LED light array and the AC to DC converter.

8. The low power consumption high illumination LED lamp of claim 6, further comprising:
a mounting member secured to a position outside the base and adjacent to the other surface of the heat sink; and
an abutment member disposed between the mounting member and the heat sink and being electrically interconnected the at least one matrix shaped LED light array and the AC to DC converter.

9. The low power consumption high illumination LED lamp of claim 7, wherein the AC to DC converter is electrically interconnected the abutment member and the metallic member, and wherein one end of the AC to DC converter coupling the metallic member is an AC input terminal and the other end of the AC to DC converter coupling the abutment member is a DC output terminal.

10. The low power consumption high illumination LED lamp of claim 8, wherein the AC to DC converter is electrically interconnected the abutment member and the metallic member, and wherein one end of the AC to DC converter coupling the metallic member is an AC input terminal and the other end of the AC to DC converter coupling the abutment member is a DC output terminal.

11. The low power consumption high illumination LED lamp of claim 9, wherein the base further comprises a top rim adapted to fasten the peripheral edge of the bulb.

12. The low power consumption high illumination LED lamp of claim 10, wherein the base further comprises a top rim adapted to fasten the peripheral edge of the bulb.

13. The low power consumption high illumination LED lamp of claim 9, wherein an output voltage at the DC output terminal is in a range of 12.5V to 13.5V.

14. The low power consumption high illumination LED lamp of claim 10, wherein an output voltage at the DC output terminal is in a range of 12.5V to 13.5V.
